(19) United States
(12) Patent Application Publication
(10) Pub. No.: US 2026/0011766 A1
(43) Pub. Date: Jan. 8, 2026

(54) BATTERY AND METHOD OF MANUFACTURING SAME

(71) Applicant: Samsung SDI Co., Ltd., Yongin-si (KR)

(72) Inventor: Taewoong JANG, Yongin-si (KR)

(21) Appl. No.: 18/963,086

(22) Filed: Nov. 27, 2024

(30) Foreign Application Priority Data
Jul. 3, 2024 (KR) 10-2024-0087662

(51) Int. Cl. H01M 10/04; H01M 50/109; H01M 50/121; H01M 50/153; H01M 50/16; H01M 50/169; H01M 50/171; H01M 50/181; H01M 50/531; H01M 50/559; H01M 50/564

(52) U.S. Cl. CPC H01M 10/0427; H01M 10/0431; H01M 50/109; H01M 50/121; H01M 50/153; H01M 50/16; H01M 50/169; H01M 50/171; H01M 50/181; H01M 50/531; H01M 50/559; H01M 50/564

(57) ABSTRACT

A battery includes an electrode assembly including a first electrode, a second electrode, and a separator wound between the first electrode and the second electrode, a cylindrical case including a bottom part, a sidewall connected to the bottom part, and an opening facing the bottom part and accommodating the electrode assembly, and a first cap assembly coupled to one end of the sidewall of the case to seal the opening, wherein the first cap assembly includes a cap plate, and each of the cap plate and the case includes an insulating material.

### CROSS REFERENCE TO RELATED APPLICATION

The present application claims priority to and the benefit of Korean Application No. 10-2024-0087662, filed on Jul. 3, 2024, in the Korean Intellectual Property Office, the entire disclosure of which is incorporated by reference herein.

### BACKGROUND

### 1. Field

Embodiments of the present disclosure described herein are related to a battery and a method of manufacturing the battery.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

A secondary battery is manufactured by inserting an electrode assembly into a case to seal a cap assembly. For example, the electrode tab connected to the electrode assembly is connected to an inner surface of the case and/or the cap assembly, and then, the case and the cap assembly are welded to each other along an outer surface of the cap assembly to seal the case. However, there is a potential problem that the electrode assembly inside the case can interfere with a welding area of the cap assembly and the case and can be damaged during the process of welding the cap assembly and the case.

The above information disclosed in this Background section is for enhancement of understanding of the background of the present disclosure, and therefore, it may contain information that does not constitute related (or prior) art.

### SUMMARY

Aspects according to one or more aspects of embodiments are directed toward addressing the above-described problems, and to provide a battery and a method of manufacturing the battery.

These and other aspects and features of the present disclosure will be described in or will be apparent from the following description of embodiments of the present disclosure.

A battery according to one or more embodiments of the present disclosure includes an electrode assembly including a first electrode, a second electrode, and a separator wound between the first electrode and the second electrode, a cylindrical case including a bottom part, a sidewall connected to the bottom part, and an opening facing the bottom part and accommodating the electrode assembly, and a first cap assembly coupled to one end of the sidewall of the case to seal the opening, wherein the first cap assembly includes a cap plate, and each of the cap plate and the case includes (e.g., is made of) an insulating material.

According to one or more embodiments of the present disclosure, at least one of the cap plate or the case may include (e.g., be made of) a reinforced plastic material.

According to one or more embodiments of the present disclosure, one end of the sidewall of the case and the cap plate may be connected to each other in a resin bonding manner.

According to one or more embodiments of the present disclosure, one end of the sidewall of the case and the cap plate may be connected to each other in a thermal fusion manner.

According to one or more embodiments of the present disclosure, the first cap assembly may further include a first terminal plate coupled to the cap plate, and the first terminal plate may include an insertion part passing through the cap plate, and a flange part extending along an outer surface of the cap plate from the insertion part.

According to one or more embodiments of the present disclosure, an adhesion layer may be between the flange part and the cap plate, and the adhesion layer may have a length of about 2 mm or more in a direction from a center of the cap plate toward an outer circumferential surface of the cap plate.

According to one or more embodiments of the present disclosure, a plurality of adhesion layers may be between the flange part and the cap plate, and the sum of lengths of the plurality of adhesion layers may be about 2 mm or more in a direction from a center of the cap plate toward an outer circumferential surface of the cap plate.

According to one or more embodiments of the present disclosure, a through-hole may be defined in the bottom part of the case, and the battery may further include a second cap assembly coupled to the through-hole.

According to one or more embodiments of the present disclosure, a first electrode tab connected to the first electrode may be connected to the first cap assembly, and a second electrode tab connected to the second electrode may be connected to the second cap assembly.

According to one or more embodiments of the present disclosure, a first electrode tab connected to the first electrode may be connected to the second cap assembly, and a second electrode tab connected to the second electrode may be connected to the first cap assembly.

According to one or more embodiments of the present disclosure, the first electrode may include a substrate, a mixture portion on the substrate, the mixture portion being coated with an active material, and a non-coating portion, substrate being exposed through the non-coating portion, and the non-coating portion of the first electrode may extend to be wound and surrounds an outer circumference of the electrode assembly.

According to one or more embodiments of the present disclosure, the first electrode tab connected to the first electrode may be in contact with an inner surface of the cap plate.

According to one or more embodiments of the present disclosure, the battery may include a coin cell or a button cell.

A method of manufacturing a battery according to one or more embodiments of the present disclosure includes preparing an electrode assembly by winding a first electrode, a second electrode, and a separator between the first electrode and the second electrode, preparing a cylindrical case including a bottom part, a sidewall connected to the bottom part, and an opening facing the bottom part, inserting the electrode assembly into the case, and coupling the case to a first cap assembly to seal the opening, wherein the first cap assembly includes a cap plate, and each of the cap plate and the case includes (e.g., is made of) an insulating material.

According to one or more embodiments of the present disclosure, at least one of the cap plate or the case may include (e.g., may be made of) a reinforced plastic material.

According to one or more embodiments of the present disclosure, the sealing may include connecting one end of the sidewall of the case to an outer circumferential surface of the cap plate in a resin bonding manner.

According to one or more embodiments of the present disclosure, the sealing may include connecting one end of the sidewall of the case to an outer circumferential surface of the cap plate in a thermal fusion manner.

According to one or more embodiments of the present disclosure, the first cap assembly may further include a first terminal plate coupled to the cap plate, wherein the first terminal plate may include an insertion part passing through the cap plate, and a flange part extending along an outer surface of the cap plate from the insertion part, an adhesion layer may be between the flange part and the cap plate, and the adhesion layer may have a length of about 2 mm or more in a direction from a center of the cap plate toward an outer circumferential surface of the cap plate.

According to one or more embodiments of the present disclosure, a through-hole may be formed in the bottom part of the case, a second cap assembly may be coupled to the through-hole, and the insertion may include connecting a first electrode tab connected to the first electrode to the first cap assembly, and connecting a second electrode tab connected to the second electrode to the second cap assembly.

According to one or more embodiments of the present disclosure, the first electrode may include a substrate, a mixture portion on the substrate, the mixture portion being coated with an active material, and a non-coating portion, the substrate being exposed through the non-coating portion, and the preparing of the electrode assembly may include winding the first electrode, the second electrode, and the separator so that the non-coating portion of the first electrode surrounds the outermost circumference of the electrode assembly.

According to one or more embodiments of the present disclosure, each of the case and the cap plate may include (e.g., may be made of) the reinforced plastic material to improve the ease of the molding work for the case and the cap plate.

According to one or more embodiments of the present disclosure, the case and the cap plate may be coupled to each other in the resin bonding manner or in the thermal fusion manner, and thus, the welding process of the case and the cap plate may not be provided. Therefore, the welding defects such as the damaged to the electrode assembly due to the welding head and the deformation of the finishing tape, which may occur during the welding process of the case and the cap plate may be prevented or reduced fundamentally.

According to one or more embodiments of the present disclosure, because each of the case and the cap plate includes (e.g., is made of) the insulating material, the insulating member for the insulation between the cap plate of the first cap assembly and the first electrode tab may not be provided, and thus, the first electrode tab may be configured to be in direct contact with the cap plate. Therefore, the space inside the battery that is not contributing to the battery capacity may be minimized or reduced to increase the energy density of the battery, and the cost of the battery manufacturing process may be reduced.

According to one or more embodiments of the present disclosure, the short circuit of the battery between the cap plate of the first cap assembly and the first terminal plate may be prevented fundamentally from occurring.

According to one or more embodiments of the present disclosure, the first adhesion layer may be provided to secure the minimum area for the fusion of the cap plate and the first terminal plate, and the second adhesion layer may be provided to secure the minimum area for the fusion of the bottom part of the case and the second terminal plate, and thus, even if the inside of the battery is in the state of relatively high temperature/high humidity, the stable sealability may be maintained.

According to one or more embodiments of the present disclosure, because the case includes (e.g., is made of) the insulating material, the material of the substrate that is capable of being applied to the outer circumference of the electrode assembly may be diversified, and thus, the battery design for one or more suitable purposes may be enabled.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 illustrates a longitudinal cross-sectional view of an example of a battery according to one or more embodiments of the present disclosure.

FIG. 2 illustrates a view of an example in which a short circuit of the battery is prevented.

FIG. 3 illustrates a view of an example of a first adhesion layer according to one or more embodiments of the present disclosure.

FIG. 4 illustrates a plan view and a cross-sectional view of an example of a first adhesion layer according to one or more embodiments of the present disclosure.

FIG. 5 illustrates a plan view and a cross-sectional view of an example of a first adhesion layer according to one or more embodiments of the present disclosure.

FIG. 6 illustrates a plan view and a cross-sectional view of an example of a first adhesion layer according to one or more embodiments of the present disclosure.

FIG. 7 illustrates an enlarged cross-sectional view of an example of an electrode assembly according to one or more embodiments of the present disclosure.

FIG. 8 illustrates a flowchart for explaining a method of manufacturing a battery according to one or more embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the present disclosure, dimensions of areas and relative sizes shown in the drawings may be exaggerated for clarity of description. That is, the dimension shown in the drawings are only for convenience of understanding and are not limited thereto. Throughout the present disclosure, like reference numerals refer to like elements throughout this disclosure.

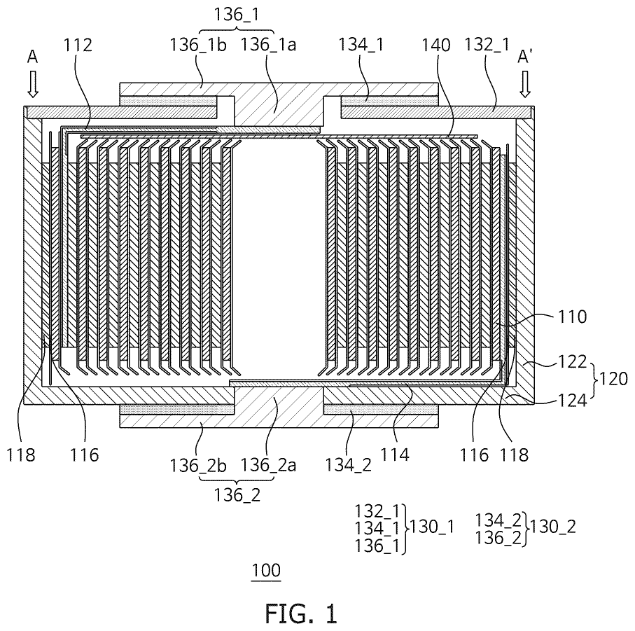

FIG. 1 illustrates a longitudinal cross-sectional view of an example of a battery 100 according to one or more embodiments of the present disclosure. The battery 100 may include an electrode assembly 110, a case 120, a first cap assembly 130_1, and a second cap assembly 130_2.

The battery 100 may be a coin-type or button-type battery. For example, the battery 100 may have a cylindrical shape. However, the battery 100 is not limited thereto and may be a prismatic type, pouch type, cylindrical type battery, etc. In one or more embodiments, the battery 100 may be a secondary battery that is chargeable and dischargeable.

The electrode assembly 110 may include a first electrode, a second electrode, and a separator. In one or more embodiments, the electrode assembly 110 may be provided by winding the separator between the first electrode and the second electrode.

The first electrode may include a first substrate and a first active material layer on the first substrate. A first electrode tab 112 may be extended outward from a first non-coating portion, on which the first active material layer is not arranged on (e.g., the first non-coating portion does not include the first active material layer), on the first substrate, and the first electrode tab 112 may be electrically connected to a first terminal plate 136_1 of the first cap assembly 130_1.

The second electrode may include a second substrate and a second active material layer on the second substrate. In one or more embodiments, a second electrode tab 114 may be extended outward from a second non-coating portion, on which the second active material layer is not on (e.g., the second non-coating portion does not include the second active material layer), on the second substrate, and the second electrode tab 114 may be electrically connected to a second terminal plate 136_2 of the second cap assembly 130_2.

The first electrode may function as a positive electrode. In one or more embodiments, the first substrate may include, for example, aluminum foil, and the first active material layer may include, for example, transition metal oxide. The second electrode may be configured to function as a negative electrode. For example, the second substrate may include, for example, copper foil or nickel foil, and the second active material layer may include, for example, graphite.

The separator may be configured to function to prevent short circuit between the first electrode and the second electrode while allowing movement of lithium ions. The separator may include, but is not limited to, a polyethylene film, a polypropylene film, a polyethylene-polypropylene film, and/or the like.

The case 120 may include a sidewall 122 having an approximately cylindrical shape and a bottom part 124 connected to one side of the sidewall 122. However, the present disclosure is not limited thereto, and the case 120 may be configured to be in one or more suitable shapes such as a circular shape or a pouch type shape.

In one or more embodiments, the case 120 may be made of an insulating material. In some embodiments, the case 120 may include (e.g., may be made of) a reinforced plastic material such as carbon fiber reinforced plastic (CFRP) or glass fiber reinforced plastic (GFRP), but the present disclosure is not limited thereto. The case 120 may include (e.g., may be made of) an insulating material and may be electrically insulated from the electrode assembly 110, the first cap assembly 130_1, and the second cap assembly 130_2.

The case 120 may accommodate the electrode assembly 110. The electrode assembly 110 may be inserted through an opening defined at one side of the case 120. That is, the electrode assembly 110 may be inserted into the case 120 through an opening defined at a side of the case 120. Thereafter, the opening of the case 120 may be sealed by the first cap assembly 130_1.

The first cap assembly 130_1 may include a cap plate 132_1, a first adhesion layer 134_1, and a first terminal plate 136_1. In one or more embodiments, the cap plate 132_1 may include (e.g. may be made of) an insulating material. In one or more embodiments, the cap plate 132_1 may include (e.g., may be made of) a reinforced plastic material such as carbon fiber reinforced plastic (CFRP) or glass fiber reinforced plastic (GFRP), but the present disclosure is not limited thereto. The cap plate 132_1 may include (e.g., may be made of) an insulating material and may be electrically insulated from the first terminal plate 136_1 and the electrode assembly 110.

The cap plate 132_1 may cover the opening of the case 120. The cap plate 132_1 may be coupled to a side surface of the case 120 corresponding to a side surface of the opening. Referring to FIG. 1, one end of the sidewall 122 of the case 120 and an outer circumferential surface of the cap plate 132_1 may be coupled to each other on coupling areas A and A′. In one or more embodiments, because both the case 120 and the cap plate 132_1 include (e.g., are made of) the insulating material (e.g., the reinforced plastic material), the case 120 and the cap plate 132_1 may be coupled to each other in a resin bonding manner or in a thermal fusion manner.

The first terminal plate 136_1 may include a first insertion part 136_1a and a first flange part 136_1b being extended from the first insertion part 136_1a. The first flange part 136_1b may be extended along an outer surface of the cap plate 132_1. The first insertion part 136_1a of the first terminal plate 136_1 may be electrically connected to the first electrode by being in contact with the first electrode tab 112. In one or more embodiments, the first electrode tab 112 may be in contact with an inner surface of the cap plate 132_1 made of the insulating material.

An insertion groove may be defined in the cap plate 132_1. For example, the insertion groove may be defined at a center of the cap plate 132_1. The first terminal plate 136_1 may be inserted into the insertion groove of the cap plate 132_1 and coupled to the cap plate 132_1. In one or more embodiments, the first insertion part 136_1a of the first terminal plate 136_1 may be inserted into the insertion groove of the cap plate 132_1.

The first adhesion layer 134_1 may be between the first terminal plate 136_1 and the cap plate 132_1. In one or more embodiments, the first adhesion layer 134_1 may be between the first flange part 136_1b of the first terminal plate 136_1 and the cap plate 132_1. The first adhesion layer 134_1 may have suitable adhesive strength to couple the first terminal plate 136_1 to the cap plate 132_1 and seal a space between the first terminal plate 136_1 and the cap plate 132_1.

A through-hole may be defined in the bottom part 124 of the case 120. For example, the through-hole may be defined at the center of the bottom part 124 of the case 120. The through-hole defined in the bottom part 124 of the case 120 may be sealed by coupling the second cap assembly 130_2.

The second cap assembly 130_2 may include a second adhesion layer 134_2 and a second terminal plate 136_2. In one or more embodiments, the second cap assembly 130_2 may have some different configurations from the first cap assembly 130_1. In one or more embodiments, the second cap assembly 130_2 may be connected by directly inserting the second terminal plate 136_2 into the through-hole of the case 120, and thus, the configuration of the cap plate may not be provided.

The second terminal plate 136_2 may include a second insertion part 136_2a and a second flange part 136_2b being extended from the second insertion part 136_2a. The second flange part 136_2b may be extended along an outer surface of the bottom part 124 of the case 120. The second insertion part 136_2a of the second terminal plate 136_2 may be inserted into a through-hole defined in the bottom part 124 of the case 120. In one or more embodiments, the second insertion part 136_2a of the second terminal plate 136_2 may be electrically connected to the second electrode by being in contact with the second electrode tab 114. The second adhesion layer 134_2 may be between the second terminal

plate 136_2 and the bottom part 124 of the case 120. In one or more embodiments, the second adhesion layer 134_2 may be between the second flange part 136_2b of the second terminal plate 136_2 and the bottom part 124 of the case 120. The second adhesion layer 134_2 may have suitable adhesive strength to couple the second terminal plate 136_2 to the case 120 and seal a space between the second terminal plate 136_2 and the case 120.

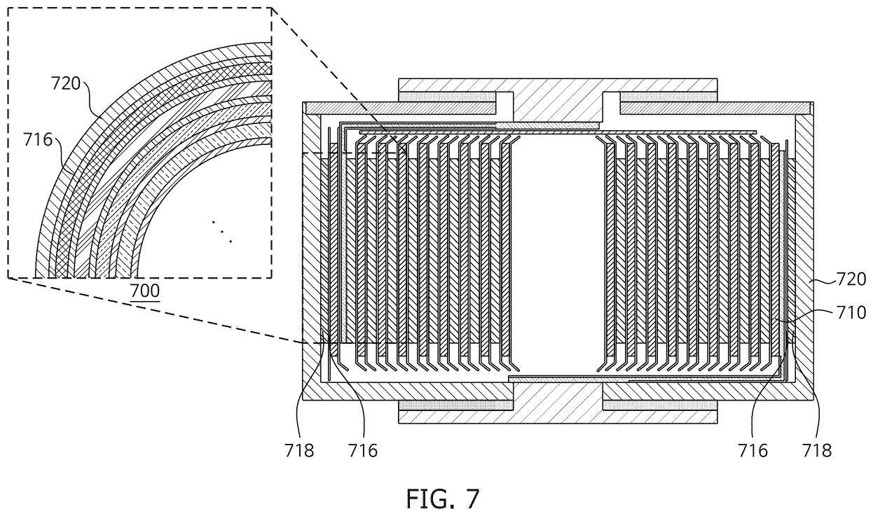

In one or more embodiments, an outer circumference of the electrode assembly 110 may be finished with a specific substrate 116. For example, a specific substrate 116 may be configured to surround the outer circumference of the electrode assembly 110. In one or more embodiments, the specific substrate 116 may be a negative electrode substrate or a positive electrode substrate. An example of the specific substrate 116 is configured to surround the outer circumference of the electrode assembly 110, which will be described in more detail with reference to FIG. 7.

In one or more embodiments, the electrode assembly 110 may include a finishing tape 118 surrounding at least a portion of the outermost circumference of the electrode assembly 110. Herein, the finishing tape 118 may secure the wound electrode assembly 110. For example, in the electrode assembly 110, the winding of the first electrode, the second electrode, and the separator may be maintained without being released by the finishing tape 118. For example, the finishing tape may have suitable adhesive strength that allows the finishing tape to surround at least a portion of the outermost circumference of the electrode assembly 110.

In one or more embodiments, the first electrode tab 112 may protrude to one side of the electrode assembly 110. The first electrode tab 112 may be bent under the first terminal plate 136_1 in the case 120 in which the electrode assembly 110 is accommodated, and the first cap assembly 130_1 is coupled. That is, at least a portion of the bent first electrode tab 112 may be between the first terminal plate 136_1 and the electrode assembly 110. The bent first electrode tab 112 may be prevented from being short-circuited with the electrode assembly 110 by an insulating washer 140. The insulating washer 140 may be between the electrode assembly 110 and the first electrode tab 112. In one or more embodiments, the insulating washer 140 may be between the first electrode tab 112 below the first terminal plate 136_1 and the electrode assembly 110. The insulating washer 140 may include an insulating material. The insulating washer 140 may separate the first electrode tab 112 and the electrode assembly 110 from each other. That is, the first electrode tab 112 and the electrode assembly 110 may be spaced apart from each other by the insulating washer 110. In one or more embodiments, the insulating washer 140 may electrically insulate the first electrode tab 112 and the electrode assembly 110 from each other.

In one or more embodiments, the second electrode tab 114 may protrude from the other side of the electrode assembly 110 in a direction that is opposite to the direction in which the first electrode tab 112 protrudes from the electrode assembly 110. The second electrode tab 114 may be bent along the bottom part 124 of the case 120. That is, at least a portion of the bent second electrode tab 114 may be between the electrode assembly 110 and the second terminal plate 136_2. In one or more embodiments, the insulating washer may be between the electrode assembly 110 and the second electrode tab 114 to prevent the short circuit between the second electrode tab 114 and the electrode assembly 110 from occurring.

In FIG. 1, the first electrode tab 112 being extended from the first electrode may be connected to the first terminal plate 136_1 of the first cap assembly 130_1, and the second electrode tab 114 being extended from the second electrode may be connected to the second terminal plate 136_2 of the second cap assembly 130_2, but the present disclosure is not limited thereto. For example, the first electrode tab 112 may be connected to the second terminal plate 136_2 of the second cap assembly 130_2, and the second electrode tab 114 may be connected to the first terminal plate 136_1 of the first cap assembly 130_1. In one or more embodiments, the second terminal plate 136_2 connected to the first electrode tab 112 may function as a positive electrode terminal, and the first terminal plate 136_1 connected to the second electrode tab 114 may function as a negative electrode terminal.

Due to this configuration, because each of the case 120 and the cap plate 132_1 includes (e.g., is made of) the reinforced plastic material, the efficiency of the molding work for the case 120 and the cap plate 132_1 may be improved. In one or more embodiments, the reinforced plastic materials may have superior or suitable corrosion resistance to acid, alkali, salt, solvent, and/or the like compared to the metal material such as aluminum, aluminum alloy, stainless steel, and nickel-plated steel, which are used in existing battery cases.

In one or more embodiments, the case 120 and the cap plate 132_1 may be coupled to each other in the resin bonding manner or in the thermal fusion manner, and thus, the welding process of the case 120 and the cap plate 132_1 may not be provided. In one or more embodiments, welding defects such as the damage of the electrode assembly 110 due to welding heat that may occur during the welding process of the case 120 and the cap plate 132_1 and deformation of the finishing tape 118 may be prevented or reduced fundamentally.

In one or more embodiments, because each of the case 120 and the cap plate 132_1 includes (e.g., is made of) the insulating material, the insulating member for the insulating material between the cap plate 132_1 of the first cap assembly 130_1 and the first electrode tab 112 may not be provided, and thus, the first electrode tab 112 may be configured to be in direct contact with the cap plate 132_1. Therefore, the space inside the battery that is not contributing to the battery capacity may be minimized or reduced, which can increase the energy density of the battery and may reduce the cost of the battery manufacturing process.

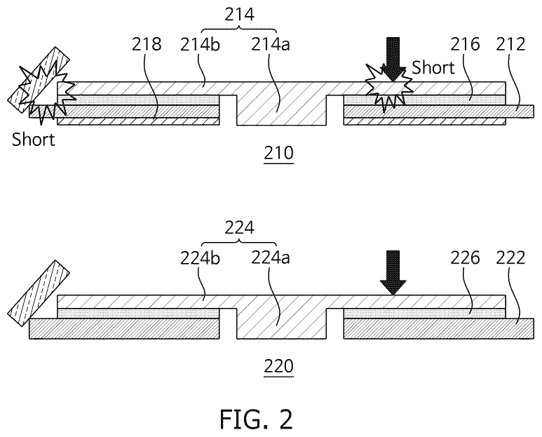

In one or more embodiments, the short circuit of the battery between the cap plate 132_1 of the first cap assembly 130_1 and the first terminal plate 136_1 may be fundamentally prevented from occurring. An example in which the short circuit of the battery is prevented will be described in more detail later with reference to FIG. 2.

FIG. 2 illustrates a view of an example in which the short circuit of the battery is prevented. A first example 210 illustrates a view of a first cap assembly according to a comparative example, and a second example 220 illustrates a view of a first cap assembly (e.g., the first cap assembly 130_1 of FIG. 1) according to one or more embodiments of the present disclosure.

The first cap assembly of the first example 210 may include a cap plate 212, a first terminal plate 214, a first adhesion layer 216, and an insulating member 218. The first terminal plate 214 may include a first insertion part 214a and a first flange part 214b being extended along an outer surface of the cap plate 212 from the first insertion part 214a. An insertion hole may be defined at a center of the cap plate 212, and the first insertion part 214a of the first terminal plate 214 may be inserted into the insertion hole of the cap plate 212, and thus, the first terminal plate 214 and the cap plate 212 may be coupled to each other.

In the first example 210, the cap plate 212 may include (e.g., may be made of) a conductive material (e.g., an electrically conductive material or electron conductor). The cap plate 212 may be electrically connected to the second electrode of the electrode assembly. In one or more embodiments, the first terminal plate 214 may be electrically connected to the first electrode of the electrode assembly.

A first adhesion layer 216 may be between the cap plate 212 and the first terminal plate 214. The first adhesion layer 216 may allow the cap plate 212 and the first terminal plate 214 to adhere to each other and seal a space between the cap plate 212 and the first terminal plate 214. In one or more embodiments, the first adhesion layer 216 may include (e.g., may be made of) an insulating material to insulate the cap plate 212 and the first terminal plate 214 from each other. In one or more embodiments, an insulating member 218 may be on a lower portion of the cap plate 212 to insulate the electrode assembly and the cap plate 212 from each other.

In the first example 210, an external object may be in contact with the first cap assembly. In one or more embodiments, in a case where the external object has conductivity, short circuit may occur between the first terminal plate 214 and the cap plate 212 even if the insulating member 218 is present. In one or more embodiments, the short circuit may occur in a case where the first adhesion layer 216 between the first terminal plate 214 and the cap plate 212 is damaged in a case where the external object applies an impact to the cap assembly.

The second example 220 may be an example of the same configuration as the first cap assembly described with reference to FIG. 1. The first cap assembly of the second example 220 may include a cap plate 222, a first terminal plate 224, and a first adhesion layer 226. The first terminal plate 224 may include a first insertion part 224a and a first flange part 224b. An insertion hole may be defined at a center of the cap plate 222, and the first insertion part 224a of the first terminal plate 214 may be inserted into the insertion hole of the cap plate 222, and thus, the first terminal plate 214 and the cap plate 222 may be coupled to each other.

In the second example 220, the cap plate 222 may include (e.g., may be made of) an insulating material. A first adhesion layer 226 may be between the cap plate 222 and the first terminal plate 224. The first adhesion layer 226 may allow the cap plate 222 and the first terminal plate 224 to adhere to each other and seal a space between the cap plate 222 and the first terminal plate 224. Because the cap plate 222 includes (e.g., is made of) the insulating material, even if the first adhesion layer 226 may not include (e.g., may not be made of) the insulating material, the cap plate 222 and the first terminal plate 224 may be insulated from each other. In one or more embodiments, because the cap plate 222 includes (e.g., is made of) the insulating material, even if the insulating member is not provided from the lower portion of the cap plate 222, the electrode assembly and the cap plate 222 may be insulated from each other.

In the second example 220, an external object may be in contact with the cap assembly. In one or more embodiments, even if the external object has conductivity (e.g., electrical conductivity), short circuit may not occur between the first terminal plate 224 and the cap plate 222 because the cap plate 222 is made of the insulating material. In one or more embodiments, the battery according to the present disclosure may be relatively safe as a risk of an occurrence of the short circuit is reduced.

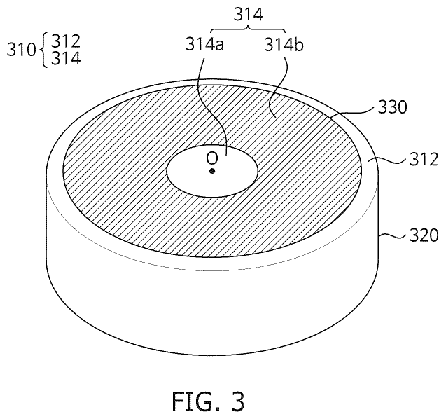

FIG. 3 illustrates a view of an example of a first adhesion layer 330 according to one or more embodiments of the present disclosure. Referring to FIG. 3, the battery may include a case 320 and a first cap assembly 310 sealing the case 320. The first cap assembly 310 may include a cap plate 312 having an insertion hole defined at a center and a first terminal plate 314. The first terminal plate 314 may include a first insertion part 314a and a first flange part 314b being extended along an outer surface of the cap plate 312 from the first insertion part 314a. The first terminal plate 314 may be coupled to the cap plate 312 by inserting the first insertion part 314a of the first terminal plate 314 into the insertion hole of the cap plate 312.

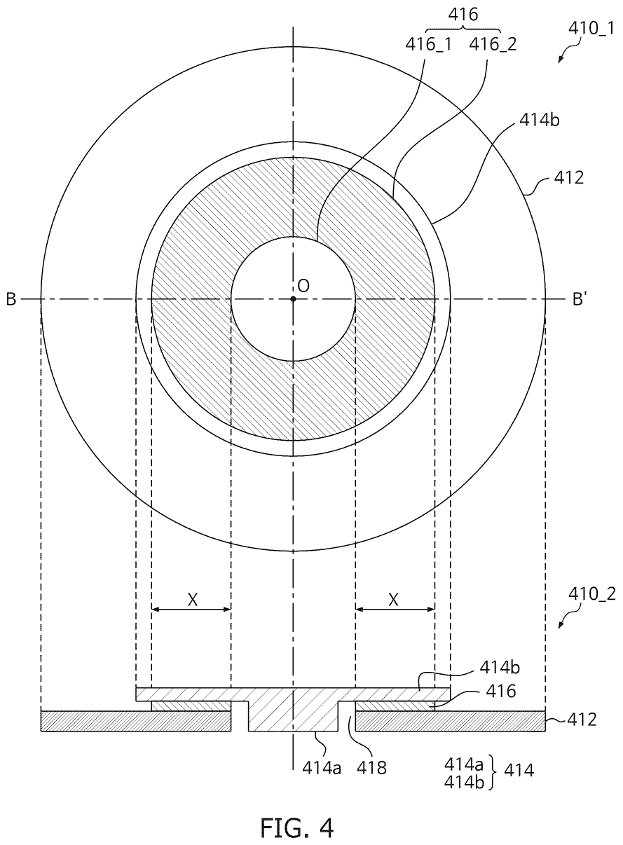

In one or more embodiments, a first adhesion layer 330 may be between the first flange part 314b and the cap plate 312. The first adhesion layer 330 may be provided in an approximately ring shape to be extended in a direction from a center O of the cap plate 312 toward an outer circumference surface of the cap plate 312. In one or more embodiments, because the first adhesion layer 330 is extended from the center O of the cap plate 312 toward the outer circumference surface of the cap plate 312 by a predetermined length or more, the first adhesion layer 330 may allow the cap plate 312 and the first terminal plate 314 to contact each other and seal a space between the cap plate 312 and the first terminal plate 314. An example of a specific configuration of the first adhesion layer 330 is described in more detail later with reference to FIGS. 4 to 6.

In one or more embodiments, the battery may further include a second cap assembly (e.g., the second cap assembly 130_2 of FIG. 1) that seals a through-hole defined in a bottom part of the case 320. The second cap assembly may include a second terminal plate and a second adhesion layer, and the second terminal plate may include a second insertion part inserted into the through-hole and a second flange part being extended along the outer surface of the bottom part of the case 320 from the second insertion part.

In one or more embodiments, the second adhesion layer may be between the second flange part and the bottom part of the case 320. Similar to the first adhesion layer 330, the second adhesion layer may be provided in an approximately ring shape to be extended in a direction from a center of the bottom part of the case 320 toward an outer circumferential surface of the bottom part. In one or more embodiments, the second adhesion layer may be extended by a predetermined length or longer from the center of the bottom part of the case 320 toward the outer circumferential surface of the bottom part so as to allow the bottom part of the case 320 and the second terminal plate to contact each other and seal a space between the bottom part of the case 320 and the second terminal plate. The second adhesion layer may be provided in a shape corresponding to the shape of the first adhesion layer 330, but is not limited thereto. An example of a specific configuration of the second adhesion layer is described in more detail with reference to the form of the first adhesion layer 330 described in more detail later in FIGS. 4 to 6.

FIG. 4 illustrates a plan view 410_1 and a cross-sectional view 410_2 of an example of a first adhesion layer 416 according to one or more embodiments of the present disclosure. A first plan view 410_1 may be a plan view illustrating a first cap assembly, and a first cross-sectional view 410_2 may be a longitudinal cross-sectional view taken along line B-B′ of the first plan view 410_1.

Referring to the first plan view 410_1 and the first cross-sectional view 410_2, the first cap assembly may include a cap plate 412, a first terminal plate 414, and a first adhesion layer 416. The first terminal plate 414 may include a first insertion part 414a and a first flange part 414b, and the first insertion part 414a may be inserted into an insertion hole 418 of the cap plate 412 to allow the first terminal plate 414 and the cap plate 412 to be coupled to each other.

In one or more embodiments, a first adhesion layer 416 may be between the first flange part 414b and the cap plate 412. The first adhesion layer 416 may be provided in an approximately ring shape to be extended in a direction from a center O of the cap plate 412 toward an outer circumference surface of the cap plate 412.

In one or more embodiments, the first adhesion layer 416 may be configured to surround the first insertion part 414a. That is the first adhesion layer 416 may be configured to be around the first insertion part 414a on opposite sides. A diameter of an inner circumference 416_1 of the first adhesion layer 416 may be larger than a diameter of the first insertion part 414a. In one or more embodiments, the diameter of the inner circumference 416_1 of the first adhesion layer 416 may correspond to a diameter of the insertion hole 418 or may be larger than the diameter of the insertion hole 418. In one or more embodiments, the diameter of an outer circumference 416_2 of the first adhesion layer 416 may correspond to a diameter of the first flange part 414b of the first terminal plate 414 or may be smaller than the diameter of the first flange part 414b.

In one or more embodiments, a length x of the first adhesion layer 416 in a direction from a center O of the cap plate 412 toward an outer circumferential surface of the cap plate 412 may be about 2 mm or more. In one or more embodiments, a difference between the diameter of the inner circumference 416_1 of the first adhesion layer 416 and the diameter of the outer circumference 416_2 of the first adhesion layer 416 may be about 4 mm or more.

In one or more embodiments, a second cap assembly may be coupled to the bottom part of the case. The second cap assembly may include a second terminal plate and a second adhesion layer, and the second terminal plate may include a second insertion part and a second flange part. The second cap assembly may be coupled to the bottom part of the case by inserting the second insertion part of the second terminal plate into the through-hole defined in the bottom part of the case. A diameter of the through-hole defined in the bottom of the case may correspond to a diameter of the insertion hole defined in the cap plate 412, but is not limited thereto.

In one or more embodiments, the second adhesion layer may correspond to a shape of the first adhesion layer 416, but the present disclosure is not limited thereto. In one or more embodiments, a diameter of an inner circumference of the second adhesion layer may correspond to the diameter of the through-hole in the bottom part of the case or may be larger than the diameter of the through-hole. In one or more embodiments, the diameter of the outer circumference of the second adhesion layer may correspond to a diameter of the second flange part of the second terminal plate or may be smaller than the diameter of the second flange part. In one or more embodiments, a length of the second adhesion layer in the direction from the center of the bottom part of the case toward the outer surface of the bottom part may be about 2 mm or more, but the present disclosure is not limited thereto.

In one or more embodiments, the first adhesion layer 416 may be provided to secure a minimum area for fusion of the cap plate 412 and the first terminal plate 414, and the second adhesion layer may be provided to secure a minimum area for fusion of the bottom part of the case and the second terminal plate, and thus, even if the inside of the battery is in the state of high temperature/high humidity, the stable sealability may be maintained.

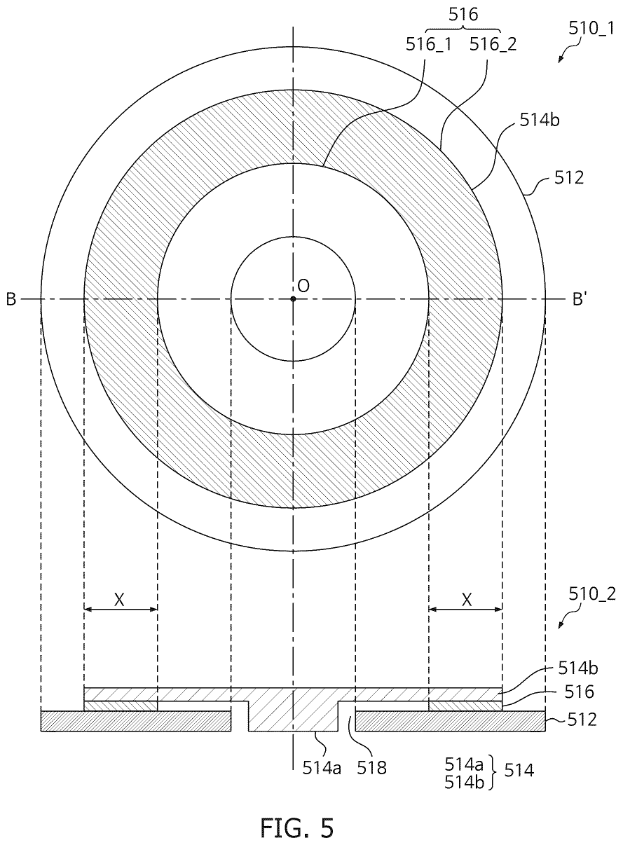

FIG. 5 illustrates a plan view and a cross-sectional view of an example of a first adhesion layer 516 according to one or more embodiments of the present disclosure. A second plan view 510_1 may be a plan view illustrating a first cap assembly, and a second cross-sectional view 510_2 may be a longitudinal cross-sectional view taken along line B-B′ of the second plan view 510_1. In FIG. 5, configurations described or duplicated in FIG. 4 may not be provided.

In one or more embodiments, a first adhesion layer 516 may be provided in an approximately ring shape. In one or more embodiments, a diameter of an inner circumference 516_1 of the first adhesion layer 516 may be larger than a diameter of a first insertion part 514a. In one or more embodiments, the diameter of the inner circumference 516_1 of the first adhesion layer 516 may be larger than a diameter of an insertion hole 518 or may correspond to the diameter of the insertion hole 518.

In one or more embodiments, a size and shape of the first adhesion layer 516 may be appropriately or suitably changed in proportion to a size and shape of a first flange part 514b of the first terminal plate 514. In one or more embodiments, a diameter of the outer circumference 516_2 of the first adhesion layer 516 may correspond to a diameter of the first flange part 514b of the first terminal plate 514. However, the present disclosure is not limited thereto, and the diameter of the outer circumference 516_2 of the first adhesion layer 516 may be smaller than the diameter of the first flange part 514b of the first terminal plate 514.

In one or more embodiments, a length x of the first adhesion layer 516 in a direction from a center O of the cap plate 512 toward an outer circumferential surface of the cap plate 512 may be about 2 mm or more. In one or more embodiments, a difference between the diameter of the inner circumference 516_1 of the first adhesion layer 416 and the diameter of the outer circumference 516_2 of the first adhesion layer 516 may be about 4 mm or more.

Likewise, a size and shape of the second adhesion layer of the second cap assembly may also be appropriately or suitably changed in proportion to a size and shape of the second flange part of the second terminal plate.

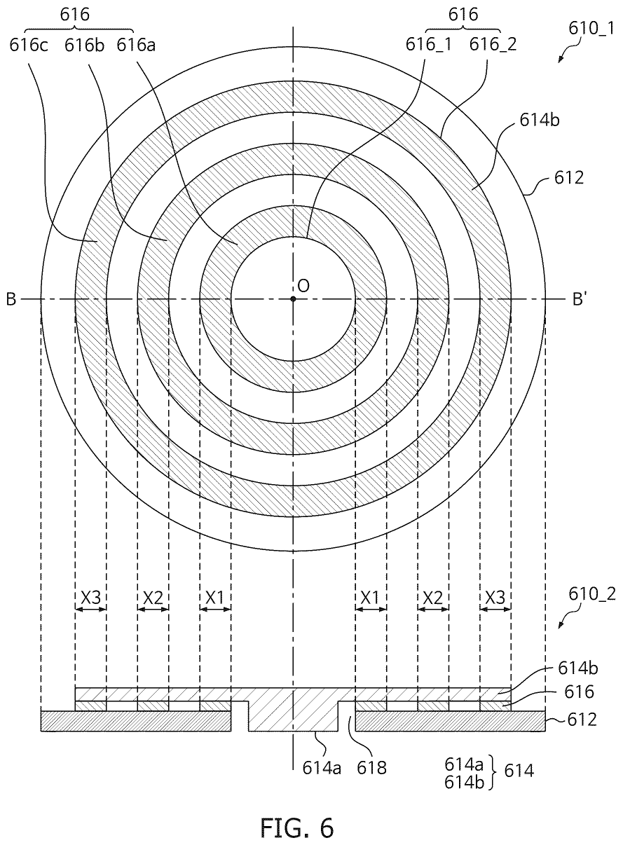

FIG. 6 illustrates a plan view and a cross-sectional view of an example of a first adhesion layer 616 according to one or more embodiments of the present disclosure. A third plan view 610_1 may be a plan view illustrating a first cap assembly, and a third cross-sectional view 610_2 may be a longitudinal cross-sectional view taken along line B-B′ of the third plan view 610_1. In FIG. 6, configurations described or duplicated in FIGS. 4 and 5 may not be provided.

In one or more embodiments, a first adhesion layer 616 may include a plurality of first adhesion layers 616a to 616c provided in a generally ring shape. Each of the first adhesion layers 616a, 616b, and 616c may be provided in the shape of concentric circles having different diameters.

In one or more embodiments, the first adhesion layers 616a, 616b, and 616c may be configured to surround a first insertion part 614a of a first terminal plate 614. That is the first adhesion layers 616a, 616b, and 616c may be configured to be around the first insertion part 614a on opposite sides. A diameter of the innermost circumference 616_1 of the first adhesion layer 616 may be larger than a diameter of the first insertion part 614a. In one or more embodiments, the diameter of the innermost circumference 616_1 of the first adhesion layer 616 may correspond to a diameter of a insertion hole 618. In one or more embodiments, a diameter of the outermost circumference 616_2 of the first adhesion layer 616 may correspond to a diameter of a first flange part 614b of the first terminal plate 614. However, the present disclosure is not limited thereto, and the diameter of the innermost circumference 616_1 of the first adhesion layer 616 may be larger than the diameter of the insertion hole 618, and the diameter of the outermost circumference 616_2 of the first adhesion layer 616 may be smaller than the diameter of the first flange part 614b of the first terminal plate 614.

In one or more embodiments, the sum of the lengths of the first adhesion layers 616a, 616b, and 616c in a direction from a center O of the cap plate 612 toward an outer circumferential surface of the cap plate 612 may be about 2 mm or more. In one or more embodiments, the sum of a length x1 of the first adhesion layer 616a in the direction from the center O of the cap plate 612 toward the outer circumferential surface of the cap plate 612, a length x2 of the first adhesion layer 616b in the direction from the center O of the cap plate 612 toward the outer circumferential surface of the cap plate 612, and a length x3 of the first adhesion layer 616c in the direction from the center O of the cap plate 612 toward the outer circumferential surface of the cap plate 612 may be about 2 mm or more.

In one or more embodiments, the second adhesion layer of the second cap assembly may also include a plurality of second adhesion layers, which are provided in the shape of concentric circles having different diameters.

In FIG. 6, three first adhesion layers 616a, 616b, and 616c may be configured to be spaced a certain distance from each other in the first adhesion layer 616, but this embodiment is not limited thereto, and the number and interval of the first adhesion layers 616 may be appropriately or suitably changed.

FIG. 7 illustrates an enlarged cross-sectional view of an example of an electrode assembly 710 according to one or more embodiments of the present disclosure. A cross-sectional view 700 may be an enlarged cross-sectional view illustrating a portion of a transverse cross-sectional view of the electrode assembly 710.

Referring to the cross-sectional view 700, an outer circumference of the electrode assembly 710 may be finished with a specific material 716. For example, a specific substrate 716 may be configured to surround the outer circumference of the electrode assembly 710. A finishing tape 718 may be attached to the outermost circumference of the electrode assembly 710. The finishing tape 718 may be attached to surround at least a portion of the electrode assembly 710 to fix the wound electrode assembly 710 so as not to be released.

In one or more embodiments, the specific substrate 716 surrounding the outer circumference of the electrode assembly 710 may be a positive electrode substrate. In one or more embodiments, the positive electrode substrate may include (e.g., may be made of) the same material as the substrate of the first electrode. In one or more embodiments, the positive electrode substrate may be arranged to surround the outer circumference of the electrode assembly 710 by extending and winding the substrate of the first electrode. In one or more embodiments, the positive electrode substrate surrounding the outer circumference of the electrode assembly 710 or the finishing tape 718 attached to surround at least a portion of the electrode assembly 710 may be in contact with an inner surface of a sidewall of the case 720.

In one or more embodiments, the specific substrate 716 surrounding the outer circumference of the electrode assembly 710 may be a negative electrode substrate. In one or more embodiments, the negative electrode substrate may include (e.g., be made of) the same material as the substrate of the second electrode. In one or more embodiments, the negative electrode substrate may be arranged to surround the outer circumference of the electrode assembly 710 by extending and winding the substrate of the second electrode. In one or more embodiments, the negative electrode substrate surrounding the outer circumference of the electrode assembly 710 or the finishing tape 718 attached to surround at least a portion of the electrode assembly 710 may be in contact with an inner surface of a sidewall of the case 720.

That is, because the case 720 includes (e.g., is made of) an insulating material, the material of the substrate that is capable of being applied to the outer circumference of the electrode assembly 710 may be diversified, and thus, the battery design for one or more suitable purposes may be enabled. For example, the outer circumference of the electrode assembly 710 may be finished with the positive electrode substrate, and thus, a design margin of the electrode assembly may be secured compared to the electrode assembly of which the outer circumference is finished with the insulating material.

In FIG. 7, only an example in which the outer circumference of the electrode assembly 710 is finished with the positive electrode substrate or the negative electrode substrate is described, but the outer circumference of the electrode assembly 710 may be finished with the separator.

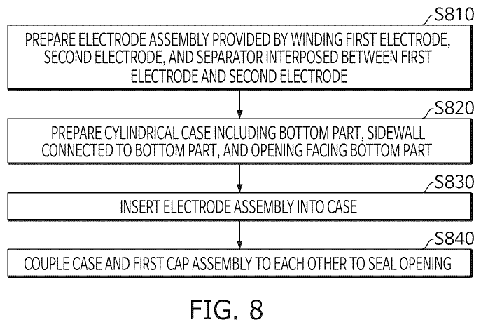

FIG. 8 illustrates a flowchart for explaining a method of manufacturing a battery according to one or more embodiments of the present disclosure. A method of manufacturing a battery may include preparing an electrode assembly including a first electrode, a second electrode, and a separator interposed between the first electrode and the second electrode (S810). In one or more embodiments, the first electrode may include a substrate, a mixture portion to which an active material is applied and a non-coating portion through which the substrate is exposed. In one or more embodiments, the process of preparing the electrode assembly may include a process of winding the first electrode, the second electrode, and the separator so that the non-coating portion of the first electrode surrounds the outermost circumference of the electrode assembly. Herein, the first electrode is a positive electrode, and the substrate of the first electrode may be a positive electrode substrate, but are not limited thereto.

Then, a cylindrical case including a bottom part, a sidewall connected to the bottom part, and an opening facing the bottom part may be prepared (S820). Thereafter, the electrode assembly may be inserted into the case (S830). In one or more embodiments, a through-hole may be defined in the bottom part of the case, and a second cap assembly may be coupled to the through-hole. The process of inserting the electrode assembly into the case may include a process of connecting a first electrode tab connected to the first electrode to the first cap assembly and a process of connecting a second electrode tab connected to the second electrode to the second cap assembly.

Then, the case and the first cap assembly may be coupled to seal the opening (S840). In one or more embodiments, the first cap assembly may include a cap plate. In one or more embodiments, each of the cap plate and the case may include (e.g., be made of) an insulating material. In one or more embodiments, at least one of the cap plate or the case may include (e.g., may be made of) a reinforced plastic material, but is not limited thereto. In one or more embodiments, one end of a sidewall of the case and an outer surface of the cap plate may be connected in a resin bonding manner or a thermal fusion manner.

In one or more embodiments, the first cap assembly may further include a first terminal plate coupled to the cap plate. The first terminal plate may include an insertion part passing through the cap plate and a flange part being extended from the insertion part along the outer surface of the cap plate. In one or more embodiment, an adhesion layer may be formed between the flange part and the cap plate. A length of the adhesion layer in a direction from a center of the cap plate toward the outer surface of the cap plate may be about 2 mm or more.

The flowchart of FIG. 8 and the description above are only examples of the present disclosure, and the scope of the present disclosure is not limited to the flowchart of FIG. 8 and the description above. For example, one or more processes in the flowchart and the descriptions described above may be added/changed/deleted, the order of one or more processes may be changed, and one or more processes may be performed simultaneously.

According to one or more embodiments of the present disclosure, each of the case and the cap plate may include (e.g., may be made of) the reinforced plastic material to improve the ease of the molding work for the case and the cap plate.

According to one or more embodiments of the present disclosure, the case and the cap plate may be coupled to each other in the resin bonding manner or the thermal fusion manner, and thus, the welding process of the case and the cap plate may not be provided. Therefore, the welding defects such as the damaged of the electrode assembly due to the welding head and the deformation of the finishing tape, which may occur during the welding process of the case and the cap plate may be prevented or reduced fundamentally.

According to one or more embodiments of the present disclosure, because each of the case and the cap plate includes (e.g., is made of) the insulating material, the insulating member for the insulation between the cap plate of the first cap assembly and the first electrode tab may not be provided, and thus, the first electrode tab may be configured to be in direct contact with the cap plate. Therefore, the space inside the battery that is not contributing to the battery capacity may be minimized or reduced to increase the energy density of the battery, and to reduce the cost of the battery manufacturing process.

According to one or more embodiments of the present disclosure, the short circuit of the battery between the cap plate of the first cap assembly and the first terminal plate may be prevented fundamentally from occurring.

According to one or more embodiments of the present disclosure, the first adhesion layer may be provided to secure the minimum area for the fusion of the cap plate and the first terminal plate, and the second adhesion layer may be provided to secure the minimum area for the fusion of the bottom part of the case and the second terminal plate, and thus, even if the inside of the battery is in the state of high temperature/high humidity, the stable sealability may be maintained.

According to one or more embodiments of the present disclosure, because the case includes (e.g., is made of) the insulating material, the material of the substrate that is capable of being applied to the outer circumference of the electrode assembly may be diversified, and thus, the battery design for the various purposes may be enabled.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

### DESCRIPTION OF SOME REFERENCE SYMBOLS

100: Battery
110: Electrode assembly
112: First electrode tab
114: Second electrode tab
116: Substrate
118: Finishing tape
120: Case
122: Sidewall
124: Bottom part
130_1: First cap assembly
130_2: Second cap assembly
132_1: Cap plate
134_1: First adhesion layer
134_2: Second adhesion layer
136_1: First terminal plate
136_1a: First insertion part
136_1b: First flange part
136_2: Second terminal plate
136_2a: Second insertion part
136_2b: Second flange part
140: Insulating washer

What is claimed is:

1. A battery comprising:
an electrode assembly comprising a first electrode, a second electrode, and a separator wound between the first electrode and the second electrode;
a cylindrical case comprising a bottom part, a sidewall connected to the bottom part, and an opening facing the bottom part and accommodating the electrode assembly; and
a first cap assembly coupled to one end of the sidewall of the case to seal the opening,
wherein the first cap assembly comprises a cap plate, and
each of the cap plate and the case includes an insulating material.

2. The battery as claimed in claim 1, wherein at least one of the cap plate or the case includes a reinforced plastic material.

3. The battery as claimed in claim 1, wherein one end of the sidewall of the case and the cap plate are connected to each other in a resin bonding manner.

4. The battery as claimed in claim 1, wherein one end of the sidewall of the case and the cap plate are connected to each other in a thermal fusion manner.

5. The battery as claimed in claim 1, wherein the first cap assembly further comprises a first terminal plate coupled to the cap plate,
wherein the first terminal plate comprises:
an insertion part passing through the cap plate; and
a flange part extending along an outer surface of the cap plate from the insertion part.

6. The battery as claimed in claim 5, wherein an adhesion layer is between the flange part and the cap plate, and
the adhesion layer has a length of about 2 mm or more in a direction from a center of the cap plate toward an outer circumferential surface of the cap plate.

7. The battery as claimed in claim 5, wherein a plurality of adhesion layers are between the flange part and the cap plate, and
the sum of lengths of the adhesion layers is about 2 mm or more in a direction from a center of the cap plate toward an outer circumferential surface of the cap plate.

8. The battery as claimed in claim 1, wherein a through-hole is defined in the bottom part of the case, and
the battery further comprises a second cap assembly coupled to the through-hole.

9. The battery as claimed in claim 8, wherein a first electrode tab connected to the first electrode is connected to the first cap assembly, and
a second electrode tab connected to the second electrode is connected to the second cap assembly.

10. The battery as claimed in claim 8, wherein a first electrode tab connected to the first electrode is connected to the second cap assembly, and
a second electrode tab connected to the second electrode is connected to the first cap assembly.

11. The battery as claimed in claim 1, wherein the first electrode comprises a substrate, a mixture portion on the substrate, the mixture portion being coated with an active material, and a non-coating portion, the substrate being exposed through the non-coating portion, and
the non-coating portion of the first electrode extends to be wound and surrounds an outer circumference of the electrode assembly.

12. The battery as claimed in claim 1, wherein the first electrode tab connected to the first electrode is in contact with an inner surface of the cap plate.

13. The battery as claimed in claim 1, wherein the battery comprises a coin cell or a button cell.

14. A method of manufacturing a battery, the method comprising:
preparing an electrode assembly by winding a first electrode, a second electrode, and a separator between the first electrode and the second electrode;
preparing a cylindrical case comprising a bottom part, a sidewall connected to the bottom part, and an opening facing the bottom part;
inserting the electrode assembly into the case; and
coupling the case to a first cap assembly to seal the opening,
wherein the first cap assembly comprises a cap plate, and
each of the cap plate and the case includes an insulating material.

15. The method as claimed in claim 14, wherein at least one of the cap plate or the case includes a reinforced plastic material.

16. The method as claimed in claim 14, wherein the sealing comprises connecting one end of the sidewall of the case to an outer circumferential surface of the cap plate in a resin bonding manner.

17. The method as claimed in claim 14, wherein the sealing comprises connecting one end of the sidewall of the case to an outer circumferential surface of the cap plate in a thermal fusion manner.

18. The method as claimed in claim 14, wherein the first cap assembly further comprises a first terminal plate coupled to the cap plate,
wherein the first terminal plate comprises:
an insertion part passing through the cap plate; and
a flange part extending along an outer surface of the cap plate from the insertion part,
wherein an adhesion layer is between the flange part and the cap plate, and
the adhesion layer has a length of about 2 mm or more in a direction from a center of the cap plate toward an outer circumferential surface of the cap plate.

19. The method as claimed in claim 14, wherein a through-hole is formed in the bottom part of the case,
a second cap assembly is coupled to the through-hole, and
the insertion comprises:
connecting a first electrode tab connected to the first electrode to the first cap assembly; and
connecting a second electrode tab connected to the second electrode to the second cap assembly.

20. The method as claimed in claim 15, wherein the first electrode comprises a substrate, a mixture portion on the substrate, the mixture portion being coated with an active material, and a non-coating portion, the substrate being exposed through the non-coating portion, and
the preparing of the electrode assembly comprises winding the first electrode, the second electrode, and the separator so that the non-coating portion of the first electrode surrounds the outermost circumference of the electrode assembly.
